(19) United States
(12) Patent Application Publication
(10) Pub. No.: US 2013/0064200 A1
(43) Pub. Date: Mar. 14, 2013

(54) BASE STATION APPARATUS, MOBILE TERMINAL APPARATUS AND COMMUNICATION CONTROL METHOD

(71) Applicants: Kazuaki Takeda, Tokyo (JP); Nobuhiko Miki, Tokyo (JP); Tetsushi Abe, Tokyo (JP)

(72) Inventors: Kazuaki Takeda, Tokyo (JP); Nobuhiko Miki, Tokyo (JP); Tetsushi Abe, Tokyo (JP)

(73) Assignee: NTT DOCOMO, INC., Tokyo (JP)

(21) Appl. No.: 13/640,068

(22) PCT Filed: Apr. 5, 2011
(86) PCT No.: PCT/JP2011/058573

§ 371 Date: Nov. 20, 2012

(30) Foreign Application Priority Data
Apr. 9, 2010 (JP) 2010-090676

(51) Int. Cl. H04W 72/04; H04W 88/00

(52) U.S. Cl. 370/329

(57) ABSTRACT

To provide a base station apparatus, a mobile terminal apparatus and a communication control method supporting respectively a plurality of mobile communication systems coexist mutually. The base station apparatus in a radio communications system in which an LTE-A system and an LTE system are placed so as to coexist with each other, the LTE-A system having a system band composed of a plurality of component carriers, the LTE system having a system band composed of a single component carrier, the base station apparatus is configured to generate ACK/NACK of HARQ to uplink transmission of a plurality of the component carriers, set offset as 0 to the component carrier used in the LTE system, set the offset to be increased beginning at the aforementioned component carrier in order of being circuited among the plurality of the component carriers, and add the aforementioned offset to the allocation resource of ACK/NACK.

### TECHNICAL FIELD

The present invention relates to a base station apparatus, a mobile terminal apparatus and a communication control method, used for a next generation mobile communication system.

### BACKGROUND ART

In a Universal Mobile Telecommunications System (UMTS) network, High Speed Downlink Packet Access (HSDPA) and/or High Speed Uplink Packet Access (HSUPA) have been adopted, and thereby the maximum feature of a system based on Wideband Code Division Multiple Access (W-CDMA) has been exploited in order to intend to improve in frequency utilization efficiency and improve in a data rate. With regard to this UMTS network, Long Term Evolution (LTE) has been examined in order to intend to achieve a further high-speed data rate, low delay, etc. (Non Patent Literature 1). In the LTE, Orthogonal Frequency Division Multiple Access (OFDMA) different from the W-CDMA are used for a downstream line (downlink) as a multiplex system, and Single Carrier Frequency Division Multiple Access (SC-FDMA) is used for an upstream line (uplink).

In the third generation system, a maximum transmission rate of approximately 2 Mbps can be achieved at a downstream line generally using 5-MHz fixed band. Meanwhile, in the LTE system, maximum transmission rates of approximately 300 Mbps at a downstream line and approximately 75 Mbps at an upstream line are achievable using variable bands (1.4 MHz to 20 MHz). Moreover, in the UMTS network, in order to intend to achieve further broader bandwidths and improvement in the speed, a succeeding system of the LTE has been also examined (e.g., LTE-Advanced (LTE-A)). Accordingly, it is expected that a plurality of these mobile communication systems coexists with each other in the future, and therefore it is considered that a structure which can support the plurality of these systems (a base station apparatus, a mobile terminal apparatus, etc.) will be required.

### CITATION LIST

### Non-Patent Literature

Non Patent Literature 1: 3GPP, TR25.912 (V7.1.0), “Feasibility study for Evolved UTRA and UTRAN”, Sep. 2006

### SUMMARY OF THE INVENTION

### Technical Problem

The present invention has been achieved in consideration of such a point, and an object thereof is to provide, in the case where a plurality of mobile communication systems coexists with each other, a base station apparatus, a mobile terminal apparatus and a communication control method for supporting each mobile communication system.

### Solution to Problem

A base station apparatus in a radio communications system in which a first communications system and a second communications system are placed so as to coexist with each other, the first communications system having a system band composed of a plurality of fundamental frequency blocks, the second communications system having a system band composed of a single fundamental frequency block, the base station apparatus including: a response signal generating unit configured to generate a response signal for retransmission with respect to a received signal of uplink received in the plurality of the fundamental frequency blocks; and an allocation unit configured to add offset to an allocation resource for the response signal for every plurality of the fundamental frequency blocks, and to allocate the response signal, wherein an offset amount is set as 0 with respect to the fundamental frequency block used in the second communications system, and is set to be increased beginning at the aforementioned fundamental frequency block in order of being circuited among the plurality of the fundamental frequency blocks.

### Technical Advantage of the Invention

According to the present invention, the offset amount with respect to the fundamental frequency block used in the second communications system is set as 0, and the offset amount is set to be increased beginning at this fundamental frequency block in order of being circuited among the plurality of the fundamental frequency blocks. Therefore, a collision between the allocation resources for the response signal can be avoided at the time of the Semi-Persistent Scheduling (SPS) transmission using the cross carrier scheduling, because a different offset amount is set for every plurality of the fundamental frequency blocks. Meanwhile, in the fundamental frequency block used in the second communications system, since the offset amount with respect to the first communications system is 0 also in the case where the second communications system does not support to offset, a collision between the allocation resources of the response signal by the offset added only to the first communications system can be avoided.

### BRIEF DESCRIPTION OF THE DRAWINGS

FIG. 1 is an explanatory diagram showing a system band of an LTE-A system;

FIG. 2 is an explanatory diagram showing an example of an allocation method of PHICH resources of an LTE system;

FIG. 3 is an explanatory diagram showing another example of the allocation method of PHICH resources of the LTE system;

FIG. 4 is an explanatory diagram showing an example of an allocation method of PHICH resources of the LTE-A system;

FIG. 5 is an explanatory diagram showing another example of the allocation method of PHICH resources of the LTE-A system;

FIG. 6 is an explanatory diagram showing an example of the allocation method of PHICH resources at the time of cross carrier scheduling;

FIG. 7 is an explanatory diagram showing an example of the allocation method of PHICH resources according to the present invention at the time where the LTE system and the LTE-A system coexist with each other;

FIG. 8 is an explanatory diagram showing a first notifying method of PHICH resource-specific information to a mobile terminal apparatus;

FIG. 9 is an explanatory diagram showing a second notifying method of the PHICH resource-specific information to the mobile terminal apparatus;

FIG. 10 is an explanatory diagram showing a structure of a mobile communication system;

FIG. 11 is an explanatory diagram showing a whole structure of a base station apparatus;

FIG. 12 is an explanatory diagram showing a whole configuration of the mobile terminal apparatus;

FIG. 13 is a functional block diagram of a baseband signal processing unit included in the base station apparatus; and

FIG. 14 is a functional block diagram of a baseband signal processing unit included in the mobile terminal apparatus.

### DESCRIPTION OF EMBODIMENTS

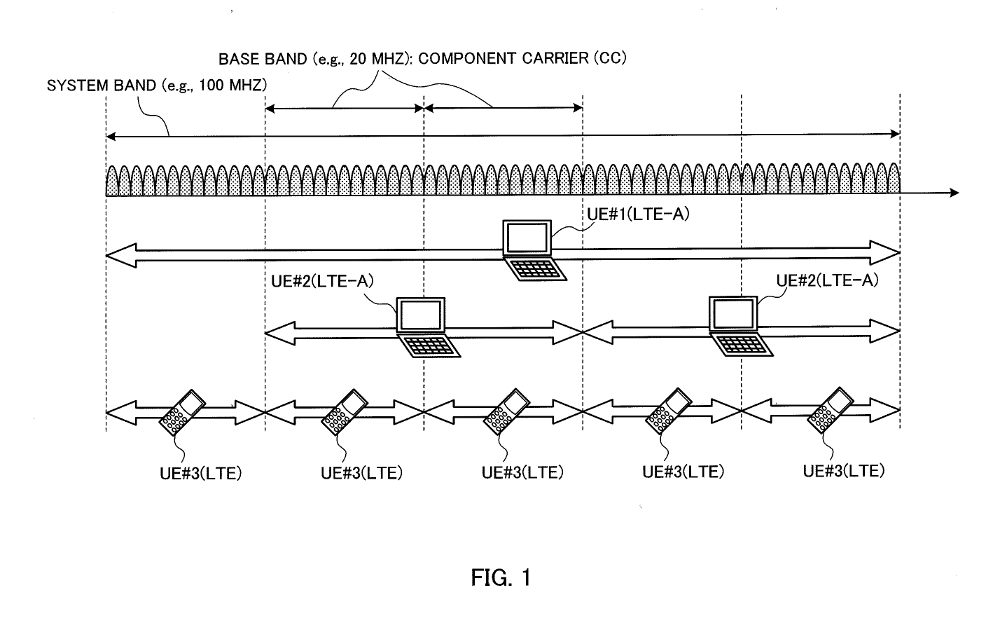

FIG. 1 is a diagram for explaining a frequency usage condition at the time when mobile communications is performed along the downlink. The example shown in FIG. 1 illustrates frequency usage conditions in the case where an LTE-A system being a first communications system composed of a plurality of fundamental frequency blocks (hereinafter, component carriers (CC)) with a relatively broad first system band and an LTE system being a second communications system with a relatively narrow second system band (herein, composed of one component carrier) coexist with each other. Radio communications are performed with a variable system bandwidth of not more than 100 MHz in the LTE-A system, and radio communications are performed with a variable system bandwidth of not more than 20 MHz in the LTE system, for example. The system band of the LTE-A system is at least one fundamental frequency block to which the system band of the LTE system is applied as one unit. To achieve broader bandwidth by integrating a plurality of the fundamental frequency blocks into one piece in this manner is named as carrier aggregation.

For example, in FIG. 1, the system band of the LTE-A system is a system band (20 MHz×5=100 MHz) including five component carrier bands to which the system band (base band: 20 MHz) of the LTE system is applied as one component carrier. In FIG. 1, a mobile terminal apparatus UE (User Equipment) #1 is a mobile terminal apparatus having a system band of 100 MHz and supporting the LTE-A system (also supporting the LTE system), a mobile terminal apparatus UE#2 is a mobile terminal apparatus having a system band of 40 MHz (=20 MHz×2) and supporting the LTE-A system (also supporting the LTE system), and a mobile terminal apparatus UE#3 is a mobile terminal apparatus having a system band of 20 MHz (base band) and supporting the LTE system (not supporting the LTE-A system).

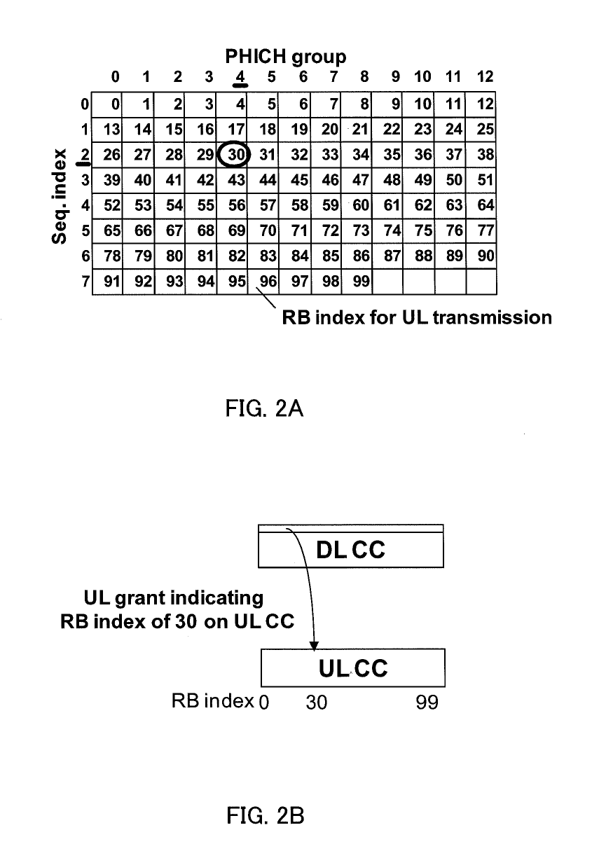

By the way, in the LTE system and LTE-A system, a base station apparatus transmits ACK or NACK of Hybrid Automatic Repeat reQuest (HARQ) with respect to uplink transmission (Physical Uplink Shared CHannel (PUSCH)) using a Physical Hybrid-ARQ Indicator CHannel (PHICH). As shown, for example in FIG. 2A, PHICH resources (allocation resources) are specified of a PHICH group and Seq.index. The PHICH group is classified for every predetermined frequency band. Seq.index indicates an orthogonal code number used in the identical frequency band (identical PHICH group). In this way, the PHICH is FDM-multiplexed (Frequency Division Multiplexing) between a plurality of the PHICH groups, and is CDM-multiplexed (Code Division Multiplexing) in an identical PHICH group.

In the LTE system (REL-8LTE), PHICH resources are allocated to a mobile terminal apparatus in accordance with a resource block number (RB index) for uplink transmission indicated by UL grant, as shown in FIG. 2B. In uplink, since it is a single carrier (SC-FDMA), leading resource block number I_{low} of continuous resource blocks is indicated by the UL grant. In the example shown in FIGS. 2A and 2B, if leading resource block number I_{low} for uplink transmission “30” is notified, PHICH resources are allocated with the PHICH group “4” and Seq.index “2”. Note that, in explanation hereinafter, DL CC illustrated in the drawings denotes a downlink component carrier, and UL CC illustrated in the drawings denotes an uplink component carrier.

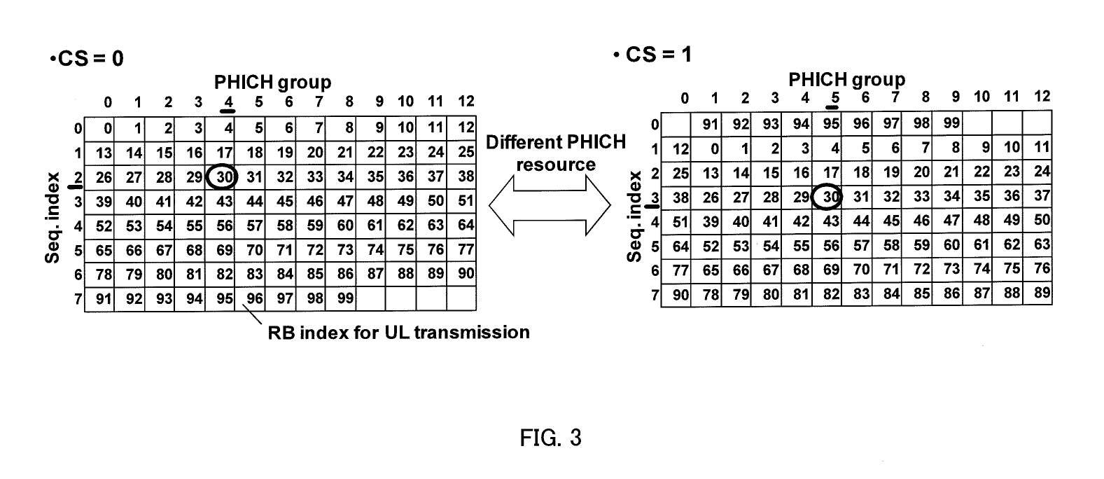

Meanwhile, in the LTE system, when a plurality of mobile terminal apparatuses use an identical I_{low} in multiuser Multiple Input Multiple Output (MIMO), a Cyclic Shift (CS) value being a parameter of an uplink Demodulation Reference Signal (DMRS) is utilized. As shown in FIG. 3, a collision between the PHICH resources can be avoided by changing the CS value for every UE. In the example shown in FIG. 3, when a plurality of mobile terminal apparatuses use an identical I_{low} “30”, PHICH resources of one mobile terminal apparatus are allocated with the PHICH group “4” and Seq.index “2” applied as the CS value “0”. Meanwhile, PHICH resources of another mobile terminal apparatus are allocated with the PHICH group “5” and Seq.index “3” applied as the CS value “1”. In this way, the PHICH resources are allocated in accordance with the leading resource block number I_{low} and CS value for uplink transmission, in the LTE system.

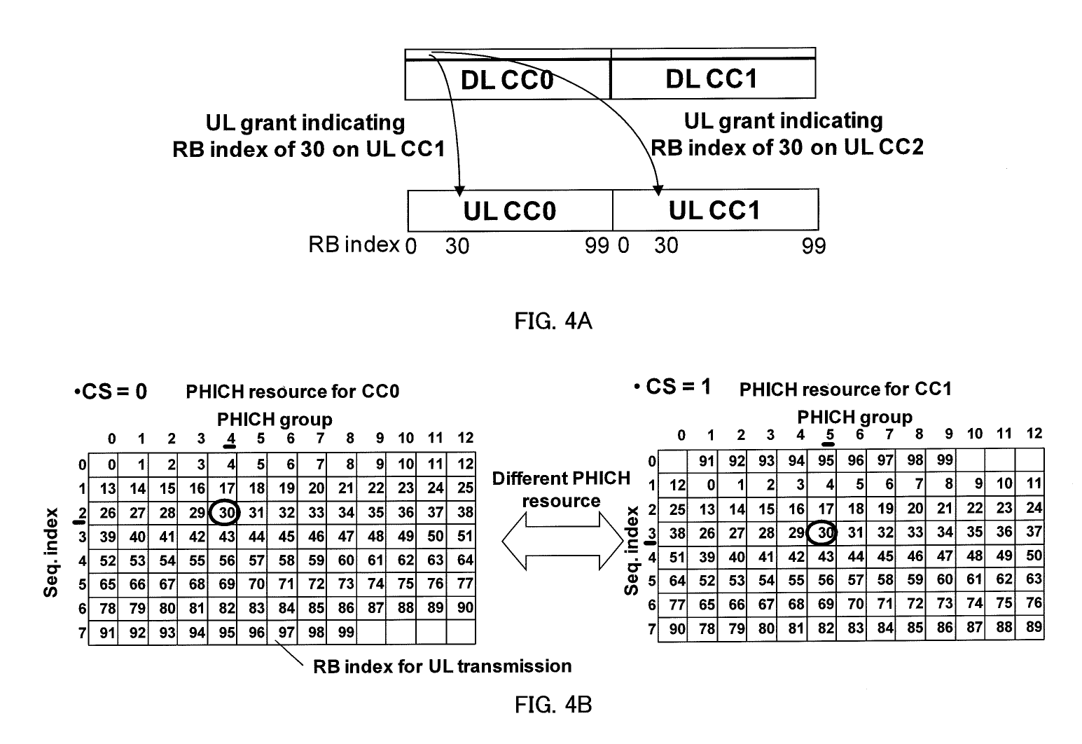

Meanwhile, in the LTE-A system (REL-10LTE), as described above, since broader bandwidths are achieved with a plurality of component carriers, cross carrier scheduling has been examined. Note that the cross carrier scheduling denotes a method of transmission using a downlink control channel using other carriers in which an effect of interference is small, instead of a component carrier which receives an excessive interference, for example. For example, as shown in FIG. 4A, when the downlink of component carrier CC#1 receives an excessive interference, UL grant is notified using a downlink control channel of component carrier CC#0.

When allocating dynamic resources at the time of this cross carrier scheduling, even if identical I_{low} is indicated by UL grant to uplinks of a plurality of component carriers, a collision between the PHICH resources can be avoided by changing CS value for every component carrier, as shown in FIG. 4B. However, if Semi-Persistent Scheduling (SPS) is applied at the time of the cross carrier scheduling, CS value is always set as “0”. Accordingly, there was a problem that PHICH resources collide with each other if identical I_{low} is indicated to uplinks of a plurality of component carriers. Note that the SPS denotes scheduling for setting persistent resources to a mobile terminal apparatus from a base station apparatus, and controlling startup of the persistent resources in the base station apparatus to perform semi-persistent scheduling. In this case, it can be considered that a method of adding offset to the PHICH resources for every component carrier is effective in avoiding such a collision between the PHICH resources.

For example, PHICH resources to which the offset is added for every component carrier are calculated according to the following expression (1).

$$\begin{matrix}[ Formula 1 ] & \\ PHICH group {n}_{PHICH}^{group} = ( {I}_{PRB\_RA}^{lowest\_index} + {n}_{CC} k + {n}_{DMRS} ) mod {N}_{PHICH}^{group} + {I}_{PHICH} {N}_{PHICH}^{group} \\ Seq . index {n}_{PHICH}^{seq} = ( ⌊ ( {I}_{PRB\_RA}^{lowest\_index} + {n}_{cc} k ) / {N}_{PHICH}^{group} ⌋ + {n}_{DMRS} ) mod 2 {N}_{SF}^{PHICH} \\ {n}_{CC} \text{:} index of scheduled CC \\ k \text{:} CC \text{-} specifc offset or constant \\ {n}_{DMRS} \text{:} CS value of DM \text{-} RS \\ {N}_{SF}^{PHICH} \text{:} Diffusion coefficient used for CDM multiplex \\ {I}_{PRB\_RA}^{lowest\_index} \text{:} Smallest RB index in uplink RB allocation \\ {N}_{PHICH}^{group} \text{:} PHICH group index \\ {I}_{PHICH} \text{:} {I}_{PHICH} = \{ \begin{matrix}1 & for TDD UL \text{/} DL configuration 0 with PUSCH transmission in subframe n = 4 or 9 \\ 0 & otherwise\end{matrix} & ( 1 )\end{matrix}$$

where n_{cc} denotes CC number (CC index) set for every component carrier, k denotes a coefficient, and n_{cc}k being a result of multiplying the CC number n_{cc} by the coefficient k denotes an offset amount set for every component carrier.

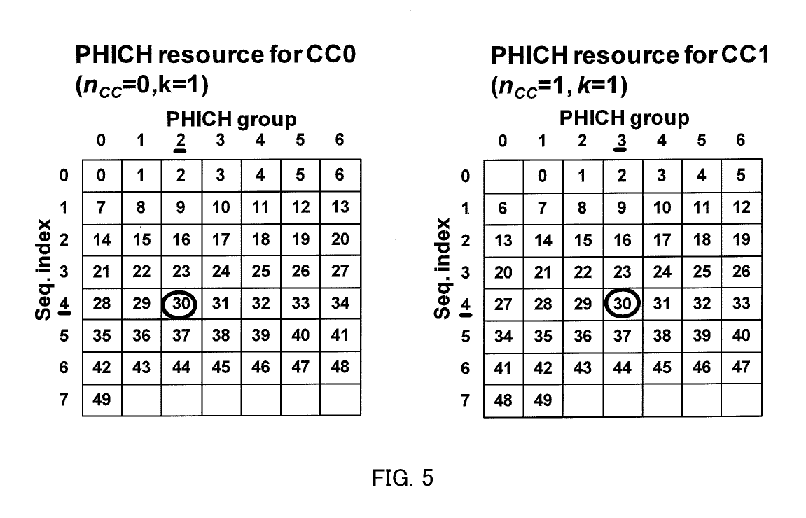

In the expression (1), the offset amount (n_{cc}k) is changed between component carriers in accordance with the CC number (n_{cc}) assigned to each component carrier. In this case, as shown in FIG. 5, if the CC number n_{cc} of component carrier CC#0=0 and k=1, the PHICH resources corresponding to I_{low} “30” are indicated by PHICH group “2” and Seq.index “4”. Mean while, if the CC number n_{cc} of component carrier CC#1=1 and k=1, the PHICH resources corresponding to I_{low} “30” are indicated by PHICH group “3” and Seq.index “4”. In this way, as for the PHICH resources corresponding to I_{low} “30” of component carrier CC#1, the offset for one group is added in a direction of the PHICH group with respect to the PHICH resources corresponding to I_{low} “30” of component carrier CC#0, and thereby a collision therebetween can be avoided. Accordingly, even if identical I_{low} is indicated to a plurality of component carriers at the time of the SPS transmission using the cross carrier scheduling, a collision between the PHICH resources can be avoided.

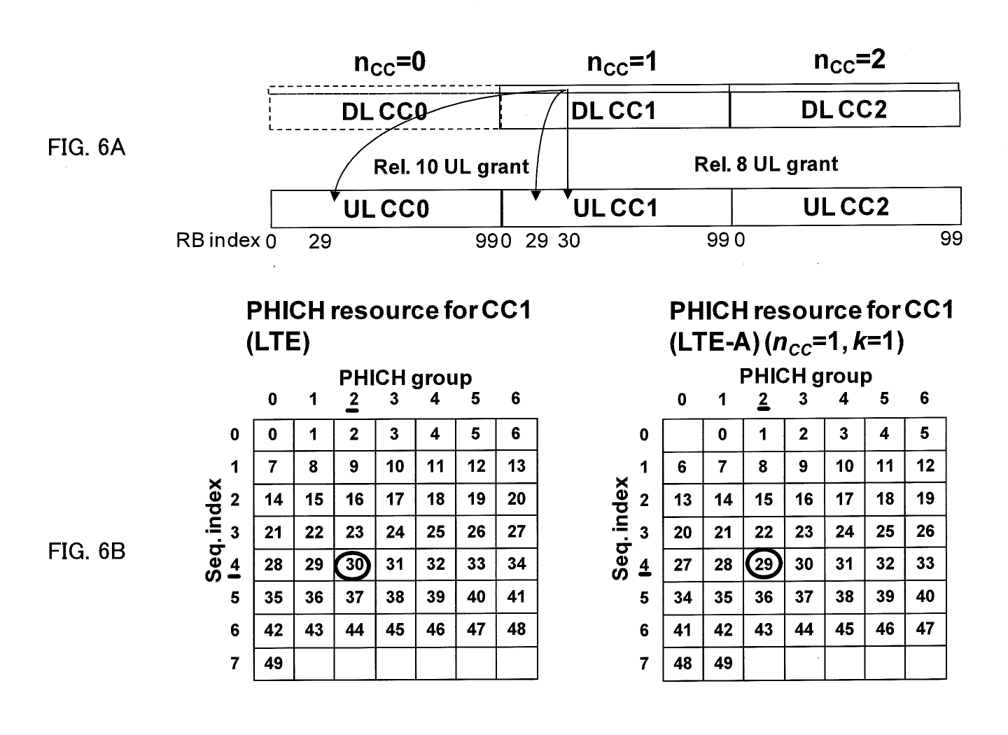

However, in a system in which the LTE system and the LTE-A system coexist with each other, even if the offset is added to the LTE-A system, a collision between the PHICH resources may not be avoided since the LTE system does not support such offset. For example, as shown in FIG. 6A, there will now be described the case where the CC number (n_{cc}) is assigned sequentially from each component carrier CC#0. In the LTE-A system, I_{low} “29” is indicated to uplink of component carriers CC#0 and CC#1 by UL grant (i.e., Rel.10 UL grant) . In the LTE system, I_{low} “30” is indicated to uplink of the component carrier CC#1 by UL grant (i.e., Rel.8 UL grant). In this case, in the component carrier CC#1, the offset is added only to the PHICH resources corresponding to I_{low} “29” of the LTE-A system since the LTE system does not support such offset. For example, as for the PHICH resources of LTE-A, if k=1 in the expression (1), the offset (n_{cc}k) for one group is added in a direction of the PHICH group. Accordingly, there was a problem that PHICH resources are collided with each other since identical PHICH resources (a PHICH group “2”, Seq.index “4”) are allocated to both the I_{low} “30” of LTE system and the I_{low} “29” of LTE-A system, as shown in FIG. 6B.

Consequently, the present inventors have arrived at the present invention, in order to solve such a problem. More specifically, the main point of the present invention is to avoid a collision between the PHICH resources by devising a way to add offset, paying attention to a collision between the PHICH resources at the time of the SPS transmission using the cross carrier scheduling, in the case where a plurality of communications systems coexist with each other.

In the present invention, an offset amount with respect to a component carrier used in common for the LTE system and the LTE-A system is set as 0, and then the offset amount is increased beginning at this component carrier in order of being circuited among a plurality of the component carriers. Accordingly, in the component carrier used in the LTE system, the offset is not added only to the PHICH resources of the LTE-A system. Therefore, in the case where a plurality of communications systems coexist with each other, a collision between the PHICH resources with respect to an upstream signal of each component carrier can be avoided at the time of the SPS transmission using the cross carrier scheduling.

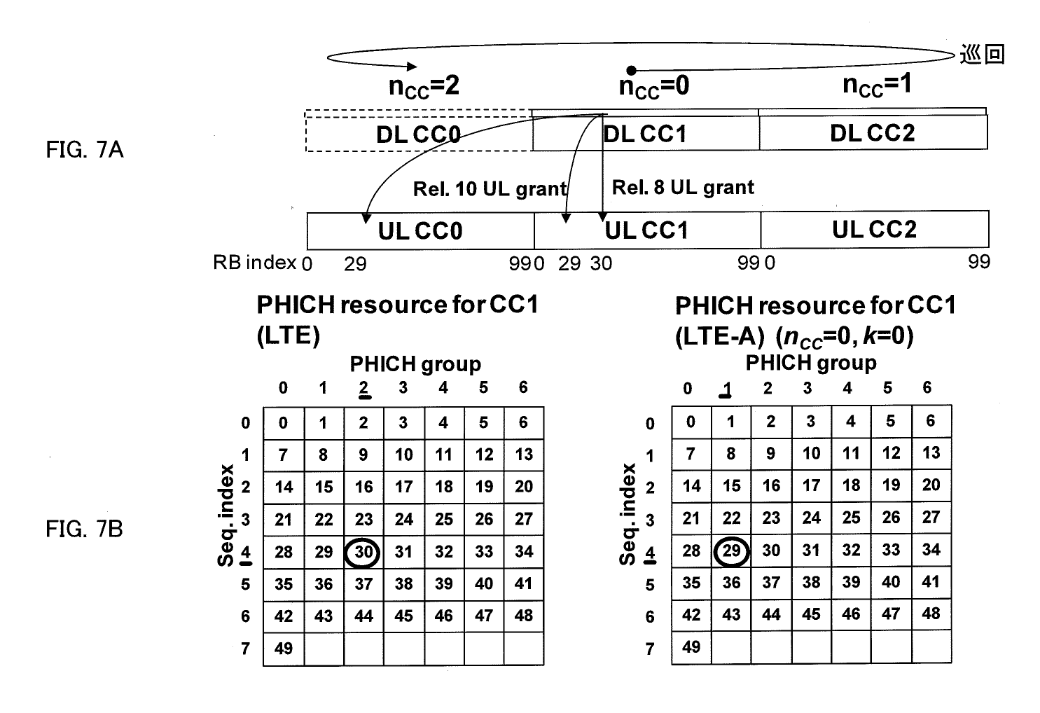

Hereinafter, embodiments of the present invention will be described in detail with reference to accompanying drawings. FIG. 7 is an explanatory diagram showing an example of an allocation method of PHICH resources in a radio communications system in which the LTE-A system as a first communications system and the LTE system as a second communications system coexist with each other.

As shown in FIG. 7A, the radio communications system has a system band composed of component carriers CC#0 to CC#2. In the LTE system, communication is performed with component carrier CC#1 and I_{low} is indicated to uplink of the component carrier CC#1 by UL grant (Rel.8 UL grant). In the LTE-A system, communication is performed with component carriers CC#0 to CC#2, and downlink of the component carrier CC#0 has received an excessive interference. Accordingly, in the LTE-A system, I_{low} is indicated to the uplink of the component carriers CC#0 and CC#1 by UL grant (Rel.10 UL grant) of the component carrier CC#1 due to the cross carrier scheduling.

Meanwhile, CC number is respectively assigned to each component carrier CC#0 to CC#2. Based on this CC number, the component carrier CC#1 used in the LTE system is set as n_{cc}=0, and the CC number is increased in order of being circuited, beginning at this component carrier CC#1. More specifically, the component carrier CC#0 is set as n_{cc}=2, the component carrier CC#1 is set as n_{cc}=0, and the component carrier CC#2 is set as n_{cc}=1. Accordingly, in component carrier CC#1, an offset amount (n_{cc}k) is become to 0 in accordance with the expression (1), and the offset is not added to the PHICH resources in both the LTE system and the LTE-A system.

Therefore, since the offset is not added only to the PHICH resources of the LTE-A system, a collision between the PHICH resources of the LTE system and the LTE-A system can be avoided. For example, in uplink of the component carrier CC#1, I_{low} “29” is indicated in the LTE-A system, and I_{low} “30” is indicated in the LTE system. Therefore, a collision between the PHICH resources can be avoided since identical PHICH resources are not allocated to I_{low} “30” of the LTE system and I_{low} “29” of the LTE-A system, as shown in FIG. 7B. In this way, according to the present embodiment, a collision between the PHICH resources can be avoided also in a system in which the LTE system and the LTE-A system coexist with each other, since the component carrier used in the LTE system is set as n_{cc}=0, and the CC number is set by being circuited, beginning at this component carrier. Moreover, since different offset is set to every component carrier, a collision between the PHICH resources can be avoided at the time of the SPS transmission using the cross carrier scheduling.

Note that, in the above-mentioned structure, the base station apparatus is structured so as to calculate the PHICH resources in accordance with the expression (1), but it is not limited to such a structure. The calculating method is not limited so long as the base station apparatus can calculate the

PHICH resources for every component carrier. Moreover, in the above-mentioned structure, the base station apparatus is structured so that the different offset amount is set for every component carrier by assigning the CC number for every component carrier, but it is not limited to such a structure. Any types of structure maybe adopted as long as the radio communications system is structured so that the offset amount to be set to the component carrier used in the LTE system is become to 0, and the different offset amount is set for every component carrier. Although it has been explained that the offset amount is set in order of component carriers CC#1, CC#2, and CC#0 as an example, the circuit direction may be a reverse direction.

In the base station apparatus, if the PHICH resources are set, a response signal for retransmission with respect to the uplink transmission (PUSCH) indicated by I_{low} is transmitted to the mobile terminal apparatus along the PHICH. In this case, since the base station apparatus adds the offset to the PHICH resources, it needs to notify PHICH resource-specific information (allocated resource-specific information), e.g. an offset amount, in order to specify PHICH resources with respect to the mobile terminal apparatus.

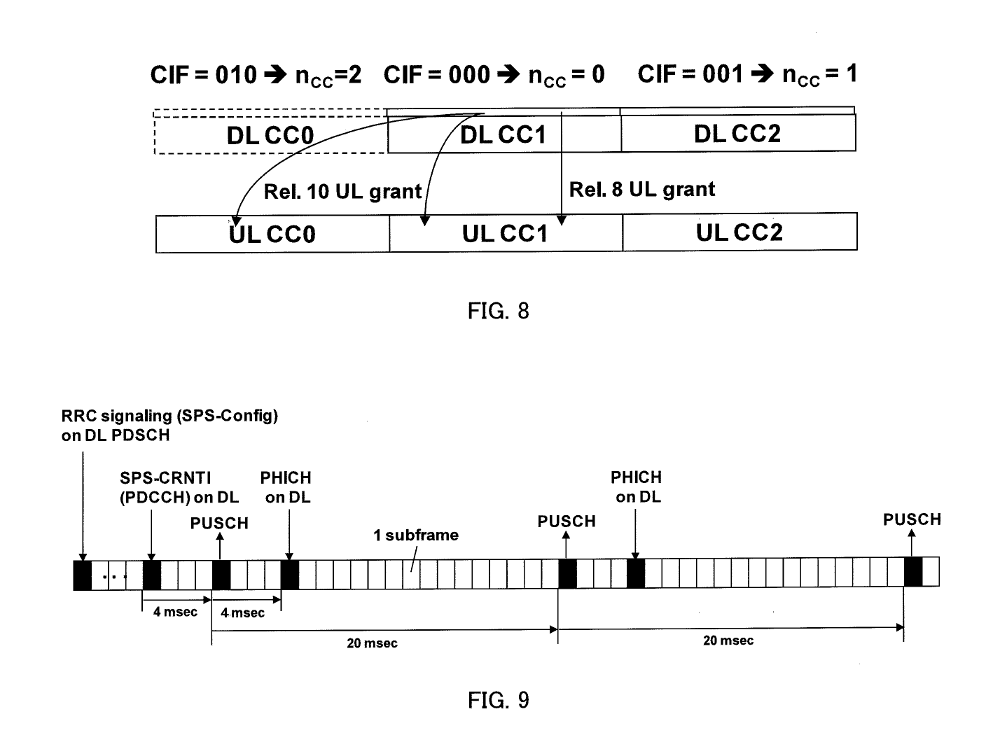

With reference to FIGS. 8 and 9, there will now be described a notifying method of the PHICH resource-specific information to the mobile terminal apparatus. FIG. 8 is an explanatory diagram showing a first notifying method of PHICH resource-specific information to the mobile terminal apparatus.

As described above, the cross carrier scheduling uses the downlink control channel of the anchor carrier in which an effect of interference is small instead of a component carrier which receives an excessive interference from other cells. In this cross carrier scheduling, a 3-bit bit field (Carrier

Indicator Field (CIF)) for setting a carrier identifier (Carrier Indicator (CI)) to downlink control information (Physical Downlink Control CHannel (PDCCH)) is added. The carrier identifier is information for indicating a transmission carrier with respect to the mobile terminal apparatus.

In the first notifying method shown in FIG. 8, CIF and CC number are associated with each other, and the offset amount added to the PHICH resources is notified to the mobile terminal apparatus with this CIF from the base station apparatus. In this case, CC number in which the offset amount is become to 0 is associated with the CIF of component carrier CC#1 used in the LTE system. The CC number in response to a relative shift amount (space amount) from the component carrier CC#1 in the circuit direction is associated with the CIF of other component carriers CC#0 and CC#2.

For example, the component carriers CC#0, CC#1 and CC#2 are respectively shown in sequence of CIF “010”, CIF “000” and CIF “001”. Meanwhile, in the mobile terminal apparatus, the

CIF “010”, CIF “000” and CIF “001” are respectively associated with n_{cc}=2, n_{cc}=0 and n_{cc}=1 sequentially. Therefore, the mobile terminal apparatus can recognize the CC number by notifying of the CIF from the base station apparatus. Furthermore, the mobile terminal apparatus calculates the offset amount based on the CC number (n_{cc}), and thereby can specify the PHICH resources.

Note that the CIF may be assigned to each component carrier statically, and may be assigned dynamically as long as it is identifiable in the mobile terminal apparatus. Moreover, in the present embodiment, although the structure in which the CIF and CC number are associated with each other is adopted, it is not limited to such a structure. The CIF and the offset amount (e.g., n_{cc}k) may be associated with each other so long as the mobile terminal apparatus is structured so as to specify the PHICH resources based on the CIF.

Next, there will now be described a second notifying method of the PHICH resource-specific information to the mobile terminal apparatus. FIG. 9 is an explanatory diagram showing the second notifying method of the PHICH resource-specific information to the mobile terminal apparatus.

As described above, in the SPS transmission, persistent resources are set to the mobile terminal apparatus from the base station apparatus, and startup of the persistent resources is controlled in the base station apparatus to perform the semi-persistent scheduling. As shown in FIG. 9, in the SPS transmission, when allocating the persistent resource to the mobile terminal apparatus, a cycle period of the persistent resource is set to the mobile terminal apparatus by SPS-Config notified using Radio Resource Control (RRC) signaling from the base station apparatus. Next, a startup of the allocated persistent resource is controlled by SPS-CRNTI notified from the base station apparatus. For example, the mobile terminal apparatus transmits uplink data after 4 sub-frames (4 msec) after the timing which received SPS-CRNTI, using PUSCH resources of fixed cycle (20 msec) indicated by PDCCH.

In the second notifying method shown in FIG. 9, at least one of the PHICH resources, the CC number and the offset amount is included in the RRC signaling transmitted to the mobile terminal apparatus from the base station apparatus in the case of the SPS transmission. A PHICH group and Seq.index are notified as the PHICH resources. As the CC number, a relative shift amount (space amount) in the circuit direction is notified for a component carrier used in the LTE system. As the offset amount, n_{cc}k in the expression (1) is notified, for example. Therefore, the mobile terminal apparatus can specify the PHICH resources by receiving the PHICH resources, the CC number, the offset amount and the like, using signaling of upper layer from the base station apparatus, etc.

Hereinafter, embodiments of the present invention will be described in detail with reference to accompanying drawings. Described herein is the case where a base station and mobile station each of which supports the LTE-A system is used.

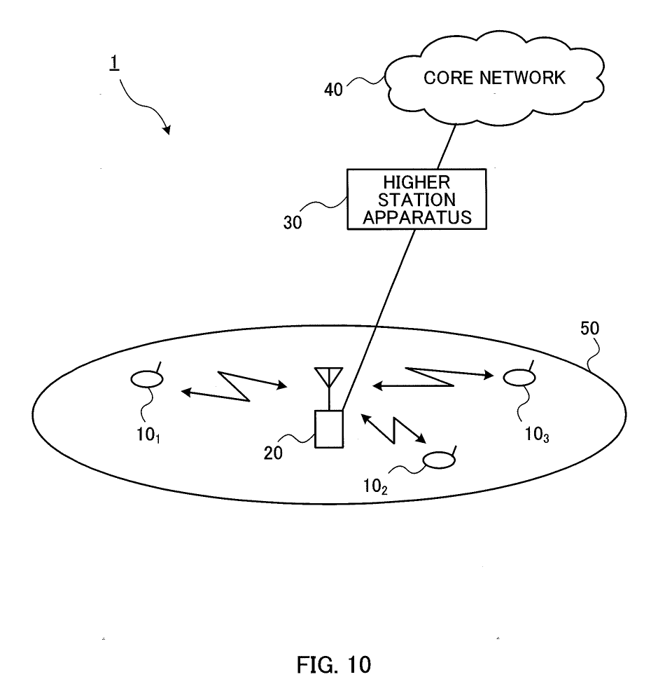

A radio communications system 1 having a mobile terminal apparatus (UE) 10 and a base station apparatus (Node B) 20 according to an embodiment of the present invention will now be described referring to FIG. 10. FIG. 10 is a diagram for explaining a structure of the radio communications system 1 having the mobile terminal apparatus 10 and the base station apparatus 20 according to this embodiment. Note that the radio communications system 1 shown in FIG. 10 is a LTE system or a system including SUPER 3G, for example. This radio communications system 1 may be referred to as IMT-Advanced, or may be referred to as 4G.

As shown in FIG. 10, the radio communications system 1 is configured to include the base station apparatus 20 and a plurality of the mobile terminal apparatuses 10 (10₁, 10₂, 10₃, . . . 10, (where n is integer greater than 0) to communicate with this base station apparatus 20. The base station apparatus 20 is connected to a higher station apparatus 30, and this higher station apparatus 30 is connected to a core network 40. The mobile terminal apparatus 10 can communicate with the base station apparatus 20 in a cell 50. Note that an access gateway unit, a radio network controller (RNC), a mobility management entity (MME), or the like are included, for example, in the higher station apparatus 30, but it is not limited to such a structure.

Although each mobile terminal apparatus (10₁, 10₂, 10₃, . . . 10ₙ) may include a LTE terminal and a LTE-A terminal, the explanation will be continued as the mobile terminal apparatus 10 so far as there is particularly no specification in below. Moreover, as a matter of convenience of explanation, although it will explains that the mobile terminal apparatus 10 performs radio communications with the base station apparatus 20, more generally, a User Equipment (UE) including a mobile terminal apparatus and a fixed terminal apparatus may also be used.

In the radio communications system 1, Orthogonal Frequency Division Multiple Access (OFDMA) is applied to downlink, and Single Carrier-Frequency Division Multiple Access (SC-FDMA) is applied to uplink, as a wireless access system. The OFDMA is a multi-carrier transmission system in which a frequency band is divided into a plurality of narrow frequency bands (subcarrier) and data is mapped in each subcarrier to perform communication. The SC-FDMA is a single carrier transmission system in which a system band is divided into bands composed of one or a continuous resource block for every terminal and a plurality of the terminals uses a different band each other, thereby reducing interference between terminals.

Described herein is a communication channel used in the LTE system.

A downlink communication channel has a Physical Downlink Control CHannel (PDSCH) shared between each mobile terminal apparatus 10, and a downlink L1/L2 control channel (PDCCH, a Physical Control Format Indicator CHannel (PCFICH), PHICH)). User data and higher control information are transmitted along this PDSCH. The higher control information includes information on addition/reduction of the number of carrier aggregation, CIF structure (“ON” and “OFF” of CIF), and RRC signaling that notifies the SPS-Config to the mobile terminal apparatus 10.

An uplink communication channel has PUSCH used sharing between each mobile terminal apparatus 10, and a Physical Uplink Control CHannel (PUCCH) which is an uplink control channel. User data are transmitted along this PUSCH. Moreover, intra-subframe frequency hopping is applied to the PUCCH, and downlink wireless quality information (Channel Quality Indicator (CQI)), ACK/NACK, etc. are transmitted thereto.

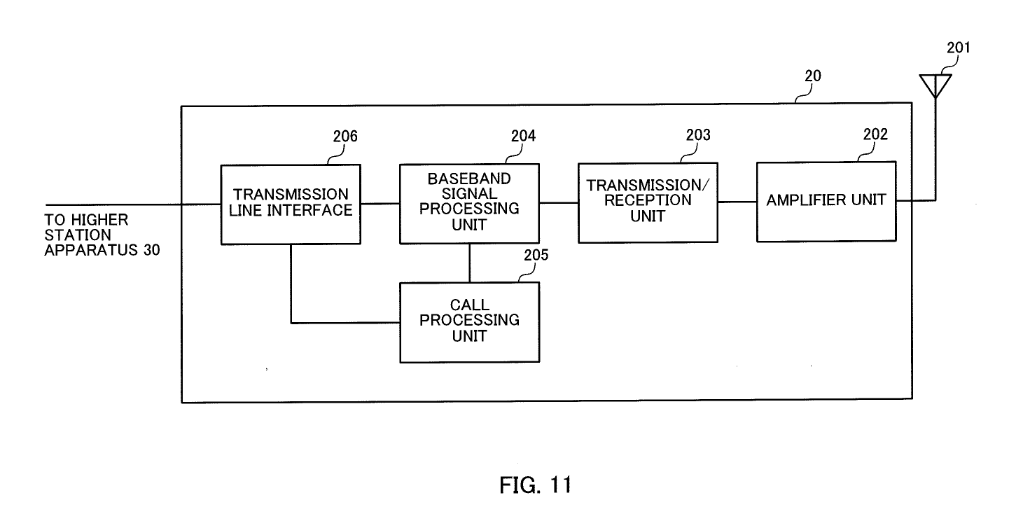

A whole structure of the base station apparatus 20 according to the present embodiment will now be described referring to FIG. 11. The base station apparatus 20 includes a transmission/reception antenna 201, an amplifier unit 202, a transmission/reception unit 203, a baseband signal processing unit 204, a call processing unit 205 and a transmission line interface 206.

User data transmitted from the base station apparatus 20 to the mobile terminal apparatus 10 via the downlink is input into the baseband signal processing unit 204 through the transmission line interface 206 from the higher station apparatus 30.

The baseband signal processing unit 204 executes processing for a PDCP layer, segmentation and concatenation of user data, transmission processing for a Radio Link Control (RLC) layer (e.g., transmission processing for RLC retransmission control), Medium Access Control (MAC) retransmission control (e.g., transmission processing for a Hybrid Automatic Repeat reQuest (HARQ), scheduling, transmission format selection, channel coding, Inverse Fast Fourier Transform (IFFT) processing, and precoding processing). Also with respect to a signal of a physical downlink control channel which is a downlink control channel, transmission processing (e.g., channel coding, inverse fast Fourier transform) is executed.

Moreover, the baseband signal processing unit 204 notifies control information for each mobile terminal apparatus to perform radio communications with the base station apparatus 20 to the mobile terminal apparatus 10 connected to the identical cell 50 along a broadcasting channel. The broadcast information for communication in the aforementioned cell 50 includes a system bandwidth in uplink or downlink, route sequence identification information (Root Sequence Index) for generating a signal of random access preamble in a Physical Random Access CHannel (PRACH), etc., for example.

The transmission/reception unit 203 frequency-converts a baseband signal output from the baseband signal processing unit 204 to a radio frequency band. The amplifier unit 202 amplifies the frequency-converted transmitting signal, and outputs the amplified transmitting signal to the transmission/reception antenna 201.

Meanwhile, with respect to a signal transmitted from the mobile terminal apparatus 10 to the base station apparatus 20 via the uplink, a radio frequency signal received with the transmission/reception antenna 201 is amplified in the amplifier unit 202, is frequency-converted in the transmission/reception unit 203 to be converted into a baseband signal, and is input into the baseband signal processing unit 204.

The baseband signal processing unit 204 executes FFT processing, IDFT processing, error correction decoding, reception processing of MAC retransmission control, reception processing of the RLC layer and the PDCP layer with respect to the user data included in the baseband signal received in the uplink. The decoded signal is transmitted to the higher station apparatus 30 through the transmission line interface 206.

The call processing unit 205 executes call processing (e.g., setting and release of the communication channel, state management of the base station apparatus 20, and management of the radio resources).

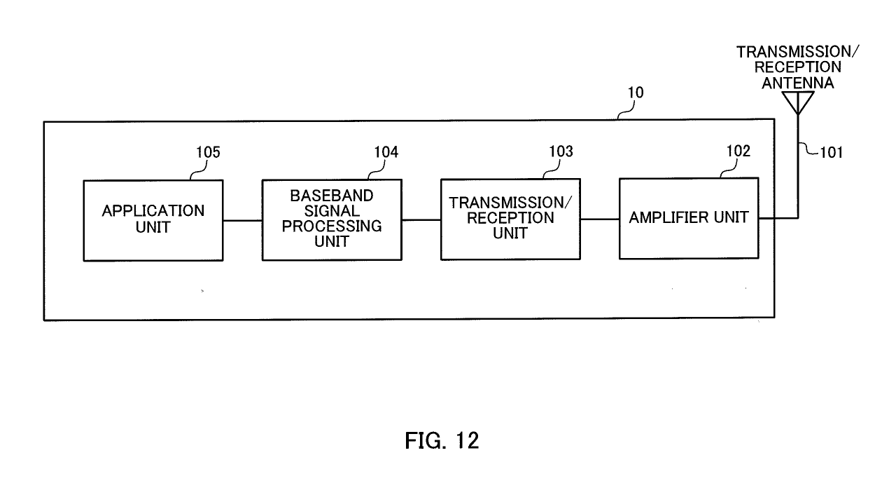

Next, a whole structure of the mobile terminal apparatus according to the present embodiment will be described, referring to FIG. 12. Since the hardware principal structures both of the LTE terminal and the LTE-A terminal are equivalent, both will be described without distinguishing therefrom. The mobile terminal apparatus 10 includes a transmission/reception antenna 101, an amplifier unit 102, a transmission/reception unit 103, a baseband signal processing unit 104 and an application unit 105.

With regard to downlink data, a radio frequency signal received with the transmission/reception antenna 101 is amplified in the amplifier unit 102, and is frequency-converted in the transmission/reception unit 103 so as to be converted into a baseband signal. With respect to this baseband signal, the baseband signal processing unit 104 executes FFT processing, error correction decoding, and reception processing of retransmission control, etc. Downlink user data among these downlink data is transmitted to the application unit 105. The application unit 105 executes processing with regard to a layer higher than the physical layer or the MAC layer. Broadcast information among the downlink data is also transmitted to the application unit 105.

Meanwhile, uplink user data is input into the baseband signal processing unit 104 from the application unit 105. The baseband signal processing unit 104 executes transmission processing of retransmission control (Hybrid ARQ (HARQ)), channel coding, DFT processing, and IFFT processing. The transmission/reception unit 103 converts the baseband signal output from the baseband signal processing unit 104 into a radio frequency band. Subsequently, the signal converted in the transmission/reception unit 103 is amplified in the amplifier unit 102 and transmitted from the transmission/reception antenna 101.

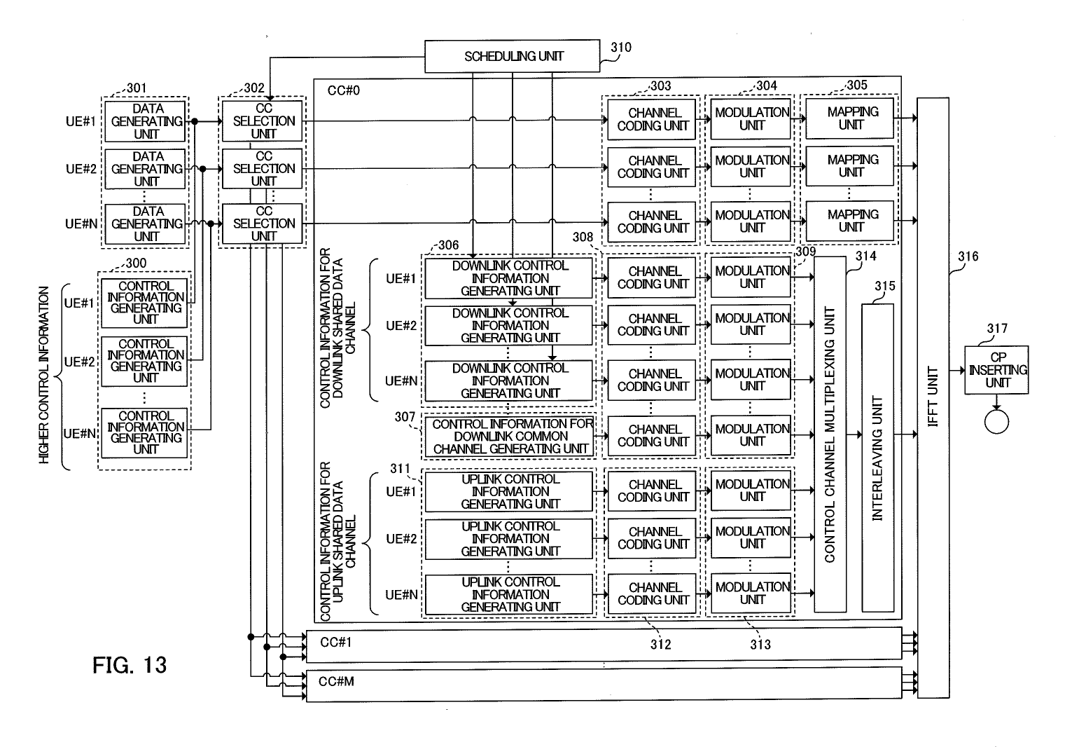

FIG. 13 is a functional block diagram showing the baseband signal processing unit 204 included in the base station apparatus 20 according to the present embodiment and a part of upper layers, and mainly shows a functional block of a transmission processing unit in the baseband signal processing unit 204. FIG. 13 shows a base station structure which can support a maximum of M pieces of the component carriers (CC#1 to CC#M). Transmitting data to the mobile terminal apparatus 10 which becomes under the command of the base station apparatus 20 is transmitted from the higher station apparatus 30 to the base station apparatus 20.

A control information generating unit 300 generates higher control information for performing higher layer signaling (e.g., RRC signaling) for every user. The higher control information can include a command for requesting instructions of a carrier number of an anchor carrier, an addition/reduction of the component carrier, and “ON” and “OFF” control of CIF. Furthermore, the higher control information may include SPS-Config. The SPS-config can include at least any one of the PHICH resources, CC number and an offset amount in addition to a cycle period of the persistent resource assigned to the mobile terminal apparatus.

A data generating unit 301 outputs transmitting data transmitted from the higher station apparatus 30 as user data for each user. A component carrier selection unit 302 selects a component carrier used for radio communications with the mobile terminal apparatus 10 for every user.

A scheduling unit 310 controls assignment of the component carrier to a mobile terminal apparatus 10 under the command thereof, in accordance with a communication quality of entire system band. Moreover, the scheduling unit 310 controls resource allocation in each component carrier CC#1 to CC#M. The scheduling unit 310 distinguishes the LTE terminal user and the LTE-A terminal user from each other to execute the scheduling. Transmitting data and retransmission instructions are input into the scheduling unit 310 from the higher station apparatus 30, meanwhile a channel estimate and CQI of resource blocks are inputted into the scheduling unit 310 from the receiving unit in which an uplink signal is measured. The scheduling unit 310 executes scheduling of uplink and downlink control information and uplink and downlink shared channel signals, referring to the retransmission instructions, the channel estimate, and CQI each input from the higher station apparatus 30. A propagation channel in mobile communications is different in variation for every frequency due to frequency selective fading. Consequently, resource blocks with satisfactory communication quality are allocated to each mobile terminal apparatus 10 for every sub-frame at the time of transmission of user data to the mobile terminal apparatus 10 (such scheduling is called Adaptive Frequency Scheduling). In the adaptive frequency scheduling, a mobile terminal apparatus 10 with satisfactory propagation channel quality is selected to be allocated to each resource block. Therefore, the scheduling unit 310 allocates resource blocks using the CQI for every resource block fed back from each mobile terminal apparatus 10. Moreover, the scheduling unit 310 determines MCS (a coding rate, a modulation method) which satisfies a predetermined block error rate in the allocated resource blocks. A parameter to satisfy the MCS (a coding rate, a modulation method) determined by the scheduling unit 310 is set to channel coding units 303, 308 and 312 and modulation units 304, 309 and 313.

The scheduling unit 310 calculates an offset amount of PHICH resources for every component carrier, and then allocates the PHICH resources. For example, as shown in FIG. 7A, the scheduling unit 310 sets CC number (n_{cc}) for every component carrier, and calculates an offset amount based on this CC number. At this time, the scheduling unit 310 sets n_{cc}=0 to the component carrier with respect to the LTE terminal user, and sets the offset amount as 0. The scheduling unit 310 further sets a value of the n_{cc} to be increased in order of being circuited, beginning at the component carrier with respect to the LTE terminal user, in order to calculate the offset amount, to other component carriers. In the component carrier shared among the LTE terminal and the LTE-A terminal, since the LTE terminal does not support the offset, such offset is not added to the PHICH resources with respect to the LTE terminal. Similarly, since the offset amount with respect to the LTE-A terminal is set as 0, such offset is not also added to the PHICH resources with respect to the LTE-A terminal. Therefore, a collision between the PHICH resources with respect to the LTE terminal and the LTE-A terminal can be avoided. Moreover, since different offset is added to every component carrier, a collision between the PHICH resources can be avoided at the time of the SPS transmission using the cross carrier scheduling.

The baseband signal processing unit 204 includes a channel coding unit 303, a modulation unit 304, and a mapping unit 305, supporting to a maximum user multiplexed number N in one component carrier. The channel coding unit 303 executes channel coding of the shared data channel (PDSCH) composed of user data (including a part of higher control signals) output from the data generating unit 301 for every user. The modulation unit 304 modulates the channel-coded user data for every user. The mapping unit 305 maps the modulated user data in radio resources.

The baseband signal processing unit 204 includes: a downlink control information generating unit 306 configured to generate control information for downlink shared data channel which is user-specific downlink control information; and a control information for downlink common channel generating unit 307 configured to generate downlink control information for common control channel which is downlink control information common to the users.

The downlink control information generating unit 306 generates a downlink control signal (DCI) of PDCCH based on the resource allocation information determined for every user, MCS information, ACK/NACK (PHICH) for HARQ, the transmission power control command of PUCCH, etc. CIF may be added to DCI. This CIF can be associated with the CC number, the offset amount, etc. in the mobile terminal apparatus 10. Accordingly, the mobile terminal apparatus 10 can obtain the CC number based on the CIF notified from the base station apparatus 20, and can specify the PHICH resources. Furthermore, the downlink control information generating unit 306 generates SPS-CRNTI notified in the PDCCH.

The baseband signal processing unit 204 includes a channel coding unit 308 and a modulation unit 309, supporting to a maximum user multiplexed number N in one component carrier. The channel coding unit 308 performs channel coding of the control information generated in the downlink control information generating unit 306 and the control information for downlink common channel generating unit 307 for every user. The modulation unit 309 modulates the channel-coded downlink control information.

Moreover, the baseband signal processing unit 204 includes: an uplink control information generating unit 311 configured to generate control information for uplink shared data channel (UL grant etc.) which is control information for controlling an uplink shared data channel (PUSCH) for every user; a channel coding unit 312 configured to execute channel coding of the generated control information for uplink shared data channel for every user; and a modulation unit 313 configured to modulate the control information for uplink shared data channel subjected to the channel coding for every user.

The control information modulated for every user in the above-mentioned modulation units 309 and 313 is multiplexed in a control channel multiplexing unit 314, and is further interleaved in an interleaving unit 315. The control signal output from the interleaving unit 315 and the user data output from the mapping unit 305 are input into an IFFT unit 316 as a downlink channel signal. The IFFT unit 316 executes inverse fast Fourier transform of the downlink channel signal so as to convert the signal into a time series signal from the frequency domain signal. A cyclic prefix inserting unit 317 inserts a cyclic prefix in the time series signal of the downlink channel signal. Note that the cyclic prefix functions as guard interval for accommodating a difference of a multipass propagation delay. The transmitting data to which the cyclic prefix is added is sent out to the transmission/reception unit 203.

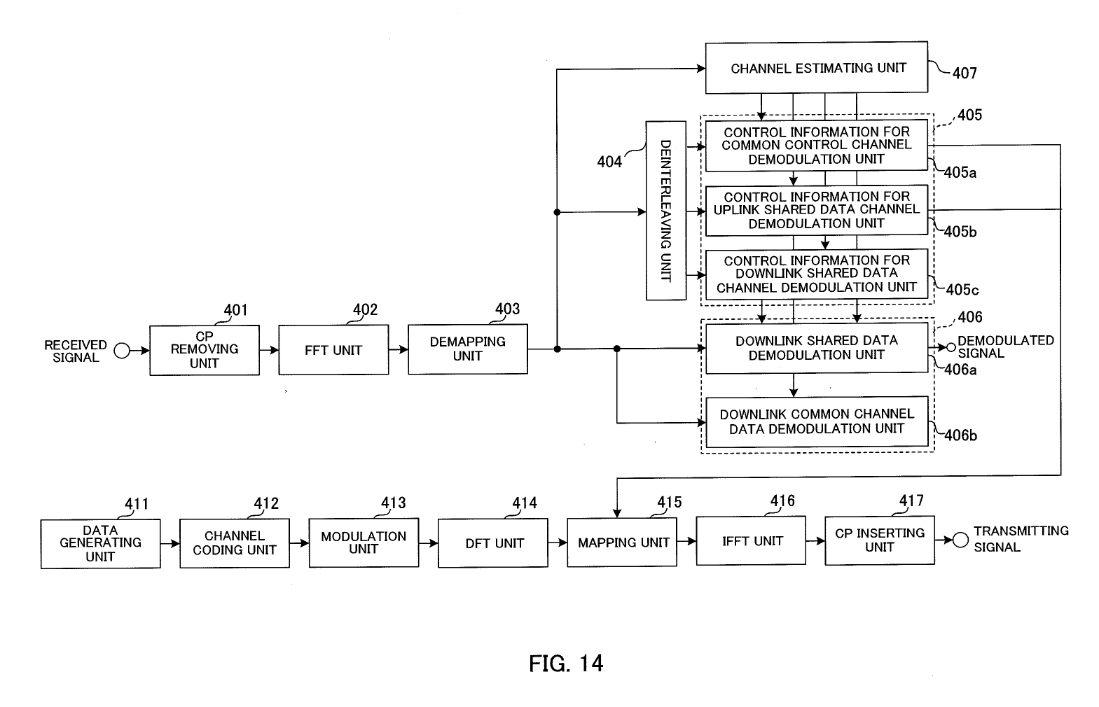

FIG. 14 is a functional block diagram showing the baseband signal processing unit 104 included in the mobile terminal apparatus 10, and shows a functional block of an LTE-A terminal which supports LTE-A. Described first is a downlink structure of the mobile terminal apparatus 10.

With regard to the downlink signal received as receive data from the radio base station apparatus 20, CP is removed in a CP removing unit 401. The downlink signal from which CP is removed is input into an FFT unit 402. The FFT unit 402 executes Fast Fourier transform (FFT) of the downlink signal so as to convert the signal into a frequency domain signal from a time domain signal, and supplies the converted signal into a demapping unit 403. The demapping unit 403 demaps the downlink signal, and extracts multiplex control information to which a plurality of control information is multiplexed, user data and higher control information from the downlink signal. Note that the demapping processing by the demapping unit 403 is executed based on the higher control information input from the application unit 105. The multiplex control information output from the demapping unit 403 is deinterleaved in a deinterleaving unit 404.

Moreover, the baseband signal processing unit 104 includes: a control information demodulation unit 405 configured to demodulate control information, a data demodulation unit 406 configured to demodulate downlink shared data, and a channel estimating unit 407. The control information demodulation unit 405 includes: a control information for common control channel demodulation unit 405a configured to demodulate downlink control information for common control channel from multiplex control information; a control information for uplink shared data channel demodulation unit 405b configured to demodulate control information for uplink shared data channel from the multiplex control information; and a control information for downlink shared data channel demodulation unit 405c configured to demodulate control information for downlink shared data channel from the multiplex control information. The data demodulation unit 406 includes: a downlink shared data demodulation unit 406a configured to demodulate user data and a higher control signal, and a downlink common channel data demodulation unit 406b configured to demodulate downlink common channel data.

The control information for common control channel demodulation unit 405a extracts the control information for common control channel which is control information common to users by blind decoding processing, demodulation processing, channel decoding processing, etc. of common search space of the multiplex control information (PDCCH). The control information for common control channel includes Channel Quality Information (CQI) of downlink, is input into a mapping unit 415 described later so as to be mapped as a part of transmitting data to be transmitted to the radio base station apparatus 20.

The control information for uplink shared data channel demodulation unit 405b extracts control information for uplink shared data channel which is user-specific uplink control information by blind decoding processing, demodulation processing, channel decoding processing, etc. of user specific search space of the multiplex control information (PDCCH). As control information for uplink shared data channel, leading resource block number I_{low} for uplink transmission is extracted, for example. The control information for uplink shared data channel is information used for control of the uplink shared data channel (PUSCH), and is input into the control information for downlink shared data channel demodulation unit 405c and the downlink common channel data demodulation unit 406b.

The control information for downlink shared data channel demodulation unit 405c extracts the control information for downlink shared data channel which is a user-specific downlink control signal by blind decoding processing, demodulation processing, channel decoding processing, etc. of user specific search space of the multiplex control information (PDCCH). Moreover, the control information for downlink shared data channel is information used for control of the downlink shared data channel (PDSCH), and is input into the downlink shared data demodulation unit 406. Moreover, the control information for downlink shared data channel demodulation unit 405c executes blind decoding processing of the user-specific search space based on information with regard to the PDCCH and PDSCH included in the higher control information demodulated in the downlink shared data demodulation unit 406a.

ACK/NACK for HARQ is extracted as the control information for downlink shared data channel. In this case, the control information for downlink shared data channel demodulation unit 405c may specify the PHICH resources based on the CIF notified from the base station apparatus 20. In this case, the control information for downlink shared data channel demodulation unit 405c calculates an offset amount based on the CC number (n_{cc}) associated with the CIF, and specifies the PHICH resources corresponding to I_{low}, so as to extract the ACK/NACK for HARQ.

The control information for downlink shared data channel demodulation unit 405c may further specify the PHICH resources based on the higher signaling from the base station apparatus 20. In this case, in the downlink shared data demodulation unit 406a, RRC signaling for notifying SPS-Config as higher control information is demodulated, and contents of the SPS-Config are determined in the upper layer. Moreover, the control information for downlink shared data channel demodulation unit 405c specifies the PHICH resources corresponding to I_{low} by feeding back at least one of the PHICH resources, the CC number, and the offset amounts included in the SPS-Config from the upper layer, and extracts the ACK/NACK for HARQ.

The downlink shared data demodulation unit 406a obtains user data and higher control information based on the control information for downlink shared data channel input from the control information for downlink shared data channel demodulation unit 405c. The higher control information (including mode information) is output to a channel estimating unit 407. The downlink common channel data demodulation unit 406b demodulates the downlink common channel data based on the control information for uplink shared data channel input from the control information for uplink shared data channel demodulation unit 405b.

The channel estimating unit 407 executes channel estimation using a common reference signal. The channel estimating unit 407 outputs the estimated channel fluctuation to the control information for common control channel demodulation unit 405a, the control information for uplink shared data channel demodulation unit 405b, the control information for downlink shared data channel demodulation unit 405c, and the downlink shared data demodulation unit 406a. In these demodulation units, the downlink signal is demodulated using the estimated channel fluctuation and the reference signal for demodulation. The baseband signal processing unit 104 includes a data generating unit 411, a channel coding unit 412, a modulation unit 413, a DFT unit 414, a mapping unit 415, an IFFT unit 416, and a CP inserting unit 417 as a functional block of transmission processing. The data generating unit 411 generates transmitting data from the bit data input from the application unit 105. The channel coding unit 412 executes channel coding processing of an error correction etc. with respect to the transmitting data, and the modulation unit 413 modulates the transmitting data subjected to the channel coding using QPSK etc. The DFT unit 414 executes discrete Fourier transform of the modulated transmitting data. The mapping unit 415 maps each frequency component of data symbol already subjected to the DFT to a subcarrier position instructed by the base station apparatus. More specifically, each frequency component of data symbol is input into the subcarrier position in the IFFT unit 416 having a bandwidth corresponding to the system band, and 0 is set to other frequency components. The IFFT unit 416 executes inverse fast Fourier transform of the input data corresponding to the system band so as to convert the data into time series data, and the CP inserting unit 417 inserts a cyclic prefix into the time series data by using data delimiter.

As mentioned above, in accordance with the base station apparatus 20 according to the present embodiment, the offset amount with respect to the component carrier used in the LTE system is set as 0, and the offset amount is set to be increased beginning at this component carrier in order of being circuited among a plurality of the component carriers. Therefore, a collision between the allocation resources of the response signal for retransmission can be avoided with a different offset amount set for every component carriers at the time of the SPS transmission using the cross carrier scheduling. Moreover, in the component carrier used in the LTE system, since the offset amount of the LTE-A system is 0 also in the case that the LTE system does not support such offset, a collision between the allocation resources of the response signal for retransmission, which is because the offset is added only to the LTE-A system, can be avoided.

Note that, in the above-mentioned embodiments, although the structure in which the PHICH resources are allocated in the scheduling unit of the base station apparatus has been described, it is not limited to such a structure. The PHICH resources may be allocated in any unit of the base station apparatus so long as the PHICH resources can be allocated by adding the offset for every component carrier.

In the above-mentioned embodiments, although the structure in which the PHICH resource-specific information is obtained in the control information for downlink shared data channel demodulation unit of the mobile terminal apparatus and the upper layer has been described, it is not limited to such a structure. So long as the PHICH resources can be specified from the PHICH resource-specific information, the mobile terminal apparatus may obtain the PHICH resource-specific information except in the control information for downlink shared data channel demodulation unit or the upper layer.

In the above-mentioned embodiments, although the PHICH resource-specific information including the CIF, the PHICH resources, the CC number, the offset amount, etc. has been described, it is not limited to such a structure. The PHICH resource-specific information may be any kind of information so long as the PHICH resources can be specified.

It is to be understood that the present invention is not limited to the embodiments described above, but various changes in form and details may be made therein. For example, with regard to the allocation of the component carrier, the number of the processing units, the processing procedures, the number of the component carriers, and the cardinal number of the component carrier in the above-mentioned explanation may be changed suitably to be implemented without departing from the scope of the invention encompassed by the appended claims. It is also possible to change others suitably to be implemented without departing from the scope of the invention encompassed by the appended claims.

This application is based upon Japanese Patent Application No. 2010-090676 filed on Apr. 9, 2010, the entire contents of which are incorporated herein by reference.

1. Abase station apparatus in a radio communications system in which a first communications system and a second communications system are placed so as to coexist with each other, the first communications system having a system band composed of a plurality of fundamental frequency blocks, the second communications system having a system band composed of a single fundamental frequency block, the base station apparatus including:
a response signal generating unit configured to generate a response signal for retransmission with respect to a received signal of uplink received in the plurality of the fundamental frequency blocks; and
an allocation unit configured to add offset to an allocation resource for the response signal for every plurality of the fundamental frequency blocks, and to allocate the response signal, wherein
an offset amount is set as 0 with respect, to the fundamental frequency block used in the second communications system, and is set to be increased beginning at the aforementioned fundamental frequency block in order of being circuited among the plurality of the fundamental frequency blocks.

2. The base station apparatus according to claim 1, wherein when downlink control information of the plurality of the fundamental frequency blocks is notified with a single fundamental frequency block to a mobile terminal apparatus, a bit field for discrimination is added to the downlink control information, the offset amount is associated with the aforementioned bit field for discrimination to be notified to the mobile terminal apparatus in order to make the mobile terminal apparatus discriminate the fundamental frequency block corresponding to the downlink control information.

3. The base station apparatus according to claim 1, wherein when executing semi-persistent scheduling with respect to the mobile terminal apparatus by controlling a startup of a persistent resource, signaling notified to the mobile terminal apparatus includes at least one of an allocation resource address of the response signal, the offset amount, and a shift amount from the fundamental frequency block to be the beginning point of the fundamental frequency blocks.

4. A mobile terminal apparatus in a radio communications system in which a first communications system and a second communications system are placed so as to coexist with each other, the first communications system having a system band composed of a plurality of fundamental frequency blocks, the second communications system having a system band composed of a single fundamental frequency block, the mobile terminal apparatus including:
an allocated resource-specific information obtaining unit configured to obtain allocated resource-specific information for specifying an allocation resource for a response signal, from the base station apparatus configured to add offset to the allocation resource for the response signal for retransmission with respect to received signal of uplink received in the plurality of the fundamental frequency blocks based on an offset amount, the offset amount being set for every plurality of the fundamental frequency blocks, being set as 0 with respect to the fundamental frequency block used in the second communications system, and being set to be increased beginning at the aforementioned fundamental frequency block in order of being circuited among the plurality of the fundamental frequency blocks; and
a response signal receiving unit configured to receive the response signal based on the allocated resource-specific information.

5. The mobile terminal apparatus according to claim 4, wherein the allocated resource-specific information is a bit field added to downlink control information in order to discriminate the fundamental frequency block corresponding to the downlink control information when the downlink control information of the plurality of the fundamental frequency blocks is notified with a single fundamental frequency block from the base station apparatus, the bit field being associated with the offset amount.

6. The mobile terminal apparatus according to claim 4, wherein the allocated resource-specific information is at least one of an allocation resource address of the response signal, the offset amount, and a shift amount from the fundamental frequency block to be the beginning point of the fundamental frequency blocks included in signaling notified from the base station apparatus when semi-persistent scheduling is executed by controlling a startup of a persistent resource by the base station apparatus.

7. A communication control method in a base station apparatus in a radio communications system in which a first communications system and a second communications system are placed so as to coexist with each other, the first communications system having a system band composed of a plurality of fundamental frequency blocks, the second communications system having a system band composed of a single fundamental frequency block, the communication control method including:
generating a response signal for retransmission with respect to a received signal of uplink received in the plurality of the fundamental frequency blocks; and
allocating the response signal by adding offset to the allocation resource based on an offset amount, the offset amount being set for every plurality of the fundamental frequency blocks, being set as 0 with respect to the fundamental frequency block used in the second communications system, and being set to be increased beginning at the aforementioned fundamental frequency block in order of being circuited among the plurality of the fundamental frequency blocks.
